(19) United States
(12) Patent Application Publication
(10) Pub. No.: US 2021/0092963 A1
(43) Pub. Date: Apr. 1, 2021

(54) CLEAN LABEL BAKING POWDER

(71) Applicant: WTI, INC., Jefferson, GA (US)

(72) Inventors: Derek Hull, Jefferson, GA (US); Garrett Campanella, Jefferson, GA (US)

(21) Appl. No.: 17/039,299

(22) Filed: Sep. 30, 2020

Related U.S. Application Data
(60) Provisional application No. 62/908,249, filed on Sep. 30, 2019.

(51) Int. Cl. A21D 2/14; A21D 2/02; A21D 2/16; A23P 10/35; A23P 20/10; A23P 20/18

(52) U.S. Cl. CPC A21D 2/145; A21D 2/02; A23P 20/18; A23P 10/35; A23P 20/11; A21D 2/16

(57) ABSTRACT

In certain example embodiments, the invention comprises an agent for leavening baked goods comprising sodium bicarbonate and dried buffered vinegar. In some embodiments, the sodium bicarbonate is encapsulated in a lipid material, such as palm oil, fractionated palm oil, fully hydrogenated palm oil, mono- and di-glycerides, fully hydrogenated cottonseed oil, or fully hydrogenated soybean oil. In another aspect, the invention provides a method of making an agent for leavening baked goods comprising mixing together sodium bicarbonate, dried buffered vinegar, and a lipid material, such as described herein.

### CROSS-REFERENCE TO RELATED APPLICATIONS

This patent application claims the benefit of U.S. Provisional Patent Application No. 62/908,249, filed Sep. 30, 2019. The entire contents of the above-identified application are hereby fully incorporated herein by reference.

### TECHNICAL FIELD

The subject matter disclosed herein is generally directed to compositions and methods for producing clean label ingredients for cooking and baking.

### BACKGROUND

Baking powder is a blend of acids and baking soda (sodium bicarbonate) that react to create gas during the baking process in baked goods. Some of the most common acids found in baking powder are Sodium Aluminum Pyrophosphate (SAPP), Sodium Aluminum Phosphate (SALP), Sodium Aluminum Sulfate (SAS) and Monocalcium Phosphate (MCP). These acids react slowly with the baking soda as the baked good heats through the baking process. Other more common organic acids can be used, such as tartaric acid, malic acid, etc., but the inherent problem is that these acids all react very quickly with the baking soda, leading to premature leavening in the product and poor rise, volume, and crumb structure. The issue that comes with the above-mentioned slower-reacting acids is that they are not considered “clean label” yet there are presently no effective natural alternatives. Therefore, there is a need for clean label leavening agents.

### SUMMARY

In certain example embodiments, the invention comprises an agent for leavening baked goods comprising sodium bicarbonate and dried buffered vinegar. In some embodiments, the dried buffered vinegar has a neutralization value of 37.5. In some embodiments, the dried buffered vinegar comprises acetic acid, citric acid, malic acid, lactic acid, or a combination thereof. In specific embodiments, the dried buffered vinegar comprises acetic acid.

In some embodiments, the sodium bicarbonate is encapsulated in a lipid material. In some embodiments, the lipid material is palm oil. In some embodiments, the palm oil is fractionated palm oil. In some embodiments, the fractionated palm oil has a melting range of 55-60° C. In some embodiments, the palm oil is fully hydrogenated palm oil. In some embodiments, the fully hydrogenated palm oil has a melting range of 58-63° C. In some embodiments, the lipid material comprises mono- and di-glycerides. In some embodiments, the mono- and di-glycerides have a melting range of 58-63° C.

In some embodiments, the lipid is fully hydrogenated cottonseed oil. In some embodiments, the fully hydrogenated cottonseed oil has a melting range of 61-65° C.

In some embodiments, the lipid is fully hydrogenated soybean oil. In some embodiments, the fully hydrogenated soybean oil has a melting range of 67-71° C.

In some embodiments, the weight of sodium bicarbonate ranges between 28-36% of the total weight of the agent. In specific embodiments, the sodium bicarbonate comprises 32% of the total weight of the agent.

In some embodiments, the weight of the dried buffered vinegar ranges between 64-72% of the total weight of the agent. In specific embodiments, the dried buffered vinegar comprises 68% of the total weight of the agent.

In another aspect, the invention provides a method of making an agent for leavening baked goods comprising mixing together sodium bicarbonate, dried buffered vinegar, and a lipid material.

In some embodiments, the dried buffered vinegar has a neutralization value of 37.5. In some embodiments, the dried buffered vinegar comprises acetic acid, citric acid, malic acid, lactic acid, or a combination thereof. In specific embodiments, the dried buffered vinegar comprises acetic acid.

In some embodiments, the weight of the sodium bicarbonate ranges between 28-36% of the total weight of the agent. In specific embodiments, the sodium bicarbonate comprises 32% of the total weight of the agent.

In some embodiments, the weight of the dried buffered vinegar ranges between 64-72% of the total weight of the agent. In specific embodiments, the dried buffered vinegar comprises 68% of the total weight of the agent.

In some embodiments, the sodium bicarbonate is encapsulated in the lipid material using a fluid bed coating process. In some embodiments, the sodium bicarbonate is encapsulated in the lipid material using a spray-chilling/cooling method.

In some embodiments, the lipid material is palm oil. In some embodiments, the lipid material is fractionated palm oil. In some embodiments, the lipid material is fully hydrogenated palm oil.

In some embodiments, the lipid material comprises mono- and di-glycerides.

In some embodiments, the lipid material is fully hydrogenated cottonseed oil. In some embodiments, the lipid material is fully hydrogenated soybean oil.

These and other aspects, objects, features, and advantages of the example embodiments will become apparent to those having ordinary skill in the art upon consideration of the following detailed description of illustrated example embodiments.

### DETAILED DESCRIPTION OF THE EXAMPLE EMBODIMENTS

### General Definitions

Unless defined otherwise, technical and scientific terms used herein have the same meaning as commonly understood by one of ordinary skill in the art to which this disclosure pertains.

As used herein, the singular forms “a”, “an”, and “the” include both singular and plural referents unless the context clearly dictates otherwise.

The term “optional” or “optionally” means that the subsequent described event, circumstance or substituent may or may not occur, and that the description includes instances where the event or circumstance occurs and instances where it does not.

The recitation of numerical ranges by endpoints includes all numbers and fractions subsumed within the respective ranges, as well as the recited endpoints.

The terms “about” or “approximately” as used herein when referring to a measurable value such as a parameter, an amount, a temporal duration, and the like, are meant to encompass variations of and from the specified value, such as variations of +/−10% or less, +/−5% or less, +/−1% or less, and +/−0.1% or less of and from the specified value, insofar such variations are appropriate to perform in the disclosed invention. It is to be understood that the value to which the modifier “about” or “approximately” refers is itself also specifically, and preferably, disclosed.

Various embodiments are described hereinafter. It should be noted that the specific embodiments are not intended as an exhaustive description or as a limitation to the broader aspects discussed herein. One aspect described in conjunction with a particular embodiment is not necessarily limited to that embodiment and can be practiced with any other embodiment(s). Reference throughout this specification to “one embodiment”, “an embodiment,” “an example embodiment,” means that a particular feature, structure or characteristic described in connection with the embodiment is included in at least one embodiment of the present invention. Thus, appearances of the phrases “in one embodiment,” “in an embodiment,” or “an example embodiment” in various places throughout this specification are not necessarily all referring to the same embodiment, but may. Furthermore, the particular features, structures or characteristics may be combined in any suitable manner, as would be apparent to a person skilled in the art from this disclosure, in one or more embodiments. Furthermore, while some embodiments described herein include some but not other features included in other embodiments, combinations of features of different embodiments are meant to be within the scope of the invention. For example, in the appended claims, any of the claimed embodiments can be used in any combination.

All publications, published patent documents, and patent applications cited herein are hereby incorporated by reference to the same extent as though each individual publication, published patent document, or patent application was specifically and individually indicated as being incorporated by reference.

### Overview

Embodiments disclosed herein provide a clean label baking powder using baking soda and dry vinegar powder. Dry vinegar powder is a type of buffered spray-dried vinegar with a relatively high acetic acid content. The acetic acid in dry vinegar powder reacts very quickly with baking soda, and therefore in an unmodified situation, it would not be a suitable leavening acid. However, if an encapsulated baking soda is used in place of raw baking soda, then the reaction is slowed and no leavening reaction will occur until the coating of the encapsulated baking soda melts during baking. This will mimic the timing of a traditional baking powder with non-clean label acids. The benefit of using a baking powder that uses this combination of ingredients is that a theoretical ingredient statement for the product would be “vinegar, sodium bicarbonate (baking soda), oil (palm oil, or whatever fat happens to be used for the coating),” which would be ideal compared to the baking powders containing the aforementioned acids.

“Clean label foods” or “clean label ingredients” comprise food items that are made exclusively from natural ingredients and/or do not contain artificial ingredients or synthetic chemicals.

Provided herein are compositions and methods for making an agent for leavening baked goods comprising sodium bicarbonate and dried buffered vinegar. In preferred embodiments, the sodium bicarbonate is encapsulated in a lipid material.

### Agents for Leavening Baked Goods

In some embodiments, the invention provides an agent for leavening baked goods. In cooking, a leavening agent, also often referred to as a raising agent, may be any one of a number of substances. Leavening agents are often used in mixtures, doughs and batters and can create gas bubbles or a foaming action in the mixtures, doughs and batters. Leavening agents may be identified by their ability to lighten, soften or contribute to the increased volume or expansion of the mixture, dough, batter, or resulting end product in which the leavening agent is used. When the leavening agent produces a gas, it is typically carbon dioxide, air, hydrogen, water vapor, or ammonia. An alternative or supplement to leavening agents is mechanical action by which air is incorporated, such as by kneading. Leavening agents may be biological agents, chemical compounds and may be used in combinations. In embodiments, the leavening agents may react in the presence of additional elements, such as moisture and heat, to form the gas bubbles that lighten, soften, expand and/or increase the volume of the mixture. In embodiments of the present invention, the leavening agent may comprise sodium bicarbonate and dried buffered vinegar.

In embodiments, the leavening agent comprises a mixture of sodium bicarbonate, and a dried buffered vinegar comprising an organic acid and a salt. In some embodiments, the weight of sodium bicarbonate ranges between 25 and 40%, between 28-36%, between 30-34%, between 31-33% of the total weight of the leavening agent. In certain embodiments, the weight of sodium bicarbonate per total weight of the leavening agent is 25%, 26%, 27%, 28%, 29%, 30%, 31%, 32%, 33%, 34%, 35%, 36%, 37%, 38%, 39%, or 40%. In specific embodiments, the sodium bicarbonate comprises 32% of the total weight of the agent. In some embodiments, the weight of the dried buffered vinegar ranges between 60% and 85%.

### Sodium Bicarbonate

Sodium bicarbonate (or sodium hydrogen carbonate), commonly known as baking soda, is a chemical compound with the formula NaHCO₃. It is a salt composed of a sodium cation (Na⁺) and a bicarbonate anion (HCO₃⁻). Sodium bicarbonate is a white solid that is crystalline, but often appears as a fine powder. It has a slightly salty, alkaline taste resembling that of washing soda (sodium carbonate). The natural mineral form is nahcolite. It is a component of the mineral natron and is found dissolved in many mineral springs.

Sodium bicarbonate may also be referred to as baking soda, bread soda, cooking soda, and bicarbonate of soda. The term baking soda is more common in the United States, whereas bicarbonate of soda is more common in Australia and Britain. In colloquial usage, the names sodium bicarbonate and bicarbonate of soda are often truncated; forms such as sodium bicarb, bicarb soda, bicarbonate, and bicarb are common.

In cooking, baking soda is primarily used in baking as a leavening. When it reacts with acid, carbon dioxide is released, which causes expansion of the batter and forms the characteristic texture and grain in pancakes, cakes, quick breads, soda bread, and other baked and fried foods. Acidic compounds that induce this reaction include phosphates, cream of tartar, lemon juice, yogurt, buttermilk, cocoa, and vinegar. Baking soda may be used together with sourdough, which is acidic, making a lighter product with a less acidic taste.

Heat can also by itself cause sodium bicarbonate to act as a raising agent in baking because of thermal decomposition, releasing carbon dioxide. When used this way on its own, without the presence of an acidic component (whether in the batter or by the use of a baking powder containing acid), only half the available CO₂ is released. Additionally, in the absence of acid, thermal decomposition of sodium bicarbonate also produces sodium carbonate, which is strongly alkaline and gives the baked product a bitter, “soapy” taste and a yellow color.

Carbon dioxide production from exposure to heat starts at temperatures above 80° C. (180° F.).

2 NaHCO₃→Na₂CO₂+H₂O+CO₂

Since the reaction occurs slowly at room temperature, mixtures (cake batter, etc.) can be allowed to stand without rising until they are heated in the oven. When adding acid, non-acid ingredients such as whole milk or Dutch-processed cocoa are often added to baked foods to avoid an overly acidic taste from the added acid.

Baking powder, also sold for cooking, contains around 30% bicarbonate, and various acidic ingredients which are activated by the addition of water, without the need for additional acids in the cooking medium. Many forms of baking powder contain sodium bicarbonate combined with calcium acid phosphate, sodium aluminum phosphate, or cream of tartar. Baking soda is alkaline; the acid used in baking powder avoids a metallic taste when the chemical change during baking creates sodium carbonate.

In some embodiments, the sodium bicarbonate may be encapsulated. Encapsulation of the baking powder allows for its release on demand. The baking powder is contained in micro-compartments that are surrounded by a coating. By creating this barrier, the entrapped material is prevented from dissolving prematurely in the dough or batter, thus allowing optimal leavening control and dough/batter rise until baking commences. In some embodiments, microencapsulation allows for longer shelf life for frozen and refrigerated dough and cake batter formulations. Such compositions may be designed to release the leaveners in response to triggers such as temperature, moisture, shear, etc. Encapsulation may protect the leavening agent from repeated freeze-thawing and provide for consistent leavening. It may also enhance dough/batter shelf life by delaying ingredient interactions and preventing premature leavening and CO₂ gas build-up. Encapsulation may also protect the leavening system from moisture during dough/batter storage. It may allow for more sustained leavening action resulting in a light and soft textured product free of discoloration.

In certain embodiments, the encapsulation material is a lipid material. When used in conjunction with a buffered spray-dried vinegar powder with a relatively high acetic acid content, as described herein, the acetic acid in the dried buffered vinegar reacts very quickly with baking soda, and therefore in an unmodified situation, it would not be a suitable leavening acid. However, if an encapsulated baking soda is used in place of raw baking soda, then the reaction is slowed and no leavening reaction will occur until the coating of the encapsulated baking soda melts during baking. This will mimic the timing of a traditional baking powder with non-clean label acids. The benefit of using a baking powder that uses this combination of ingredients is that a theoretical ingredient statement for the product would be “vinegar, sodium bicarbonate (baking soda), palm oil (or whatever fat happens to be used for the coating),” which would be ideal compared to the baking powders containing the aforementioned acids.

### Lipid Materials

A lipid material can be used to partially or fully encapsulate the sodium bicarbonate. In certain embodiments, the lipid material is a solid fat selected by its melting point. In embodiments, the melting point of the lipid is between about 40° C. and 90° C.

In some embodiments, the lipid may be high molecular weight fully hydrogenated fat or oil. The fat may have an iodine value of less than about 15, 14, 13, 12, 11, 10, 9, 8, 7, 6, or 5 or less. Vegetable oils may be used such as soybean oil, cottonseed oil, sesame oil, sunflower oil, safflower oil, peanut oil, palm oil, corn oil, and oils of the Cruciferae family, such as rapeseed oil. Fully hydrogenated fats may also be defined by their lack of trans fat or amount of stearic acid.

In some embodiments, the lipid material used for encapsulation is palm oil. Palm oil is an edible vegetable oil derived from the mesocarp (reddish pulp) of the fruit of the oil palms, primarily the African oil palm Elaeis guineensis, and to a lesser extent from the American oil palm Elaeis oleifera and the maripa palm Attalea maripa. Palm oil is naturally reddish in color because of a high beta-carotene content. It is not to be confused with palm kernel oil derived from the kernel of the same fruit or coconut oil derived from the kernel of the coconut palm (Cocos nucifera). The differences are in color (raw palm kernel oil lacks carotenoids and is not red), and in saturated fat content: palm mesocarp oil is 49% saturated, while palm kernel oil and coconut oil are 81% and 86% saturated fats, respectively. However, crude red palm oil that has been refined, bleached and deodorized, a common commodity called RBD palm oil, does not contain carotenoids. Many industrial food applications of palm oil use fractionated components of palm oil (often listed as “modified palm oil”) whose saturation levels can reach 90%; these “modified” palm oils can become highly saturated, but are not necessarily hydrogenated. In embodiments, the lipid may be a hard structural fat that is a trans free fat, e.g. a palm oil or palm kernel oil fraction, e.g. as described in WO2005122777. In specific embodiments, the lipid material is fractionated palm oil. In some embodiments, the lipid material is fully hydrogenated palm oil. In some embodiments, the lipid material comprises mono- and di-glycerides.

In some embodiments, the lipid material used for encapsulation is fully hydrogenated cottonseed oil. Cottonseed oil is cooking oil from the seeds of cotton plants of various species, mainly Gossypium hirsutum and Gossypium herbaceum, that are grown for cotton fiber, animal feed, and oil. Cotton seed has a similar structure to other oilseeds such as sunflower seed, having an oil-bearing kernel surrounded by a hard outer hull; in processing, the oil is extracted from the kernel. Cottonseed oil is used for salad oil, mayonnaise, salad dressing, and similar products because of its flavor stability. Its fatty acid profile generally consists of 70% unsaturated fatty acids (18% monounsaturated, and 52% polyunsaturated), 26% saturated fatty acids. When it is fully hydrogenated, its profile is 94% saturated fat and 2% unsaturated fatty acids (1.5% monounsaturated, and 0.5% polyunsaturated).[4] According to the cottonseed oil industry, cottonseed oil does not need to be hydrogenated as much as other polyunsaturated oils to achieve similar results.

In some embodiments, the lipid material used for encapsulation is fully hydrogenated soybean oil. Soybean oil is a vegetable oil extracted from the seeds of the soybean (Glycine max). It is one of the most widely consumed cooking oils. As a drying oil, processed soybean oil is also used as a base for printing inks (soy ink) and oil paints. Per 100 g, soybean oil has 16 g of saturated fat, 23 g of monounsaturated fat, and 58 g of polyunsaturated fat. The major unsaturated fatty acids in soybean oil triglycerides are the polyunsaturates alpha-linolenic acid (C-18:3), 7-10%, and linoleic acid (C-18:2), 51%; and the monounsaturated oleic acid (C-18:1), 23%. It also contains the saturated fatty acids stearic acid (C-18:0), 4%, and palmitic acid (C-16:0), 10%.

The high proportion of oxidation-prone polyunsaturated fatty acid is undesirable for some uses, such as cooking oils. Accordingly, hydrogenation may be used to reduce the unsaturation in linolenic acid. The resulting oil is called hydrogenated soybean oil. If the hydrogenation is only partially complete, the oil may contain small amounts of trans fat.

In some embodiments, the lipid material is palm oil.

In some embodiments, the palm oil is fractionated palm oil. In some embodiments, the fractionated palm oil has a melting point range of 55-60° C.

In some embodiments, the palm oil is fully hydrogenated palm oil. In some embodiments, the fully hydrogenated palm oil has a melting point range of 58-63° C.

In some embodiments, the lipid material comprises mono- and di-glycerides. In some embodiments, the mono- and di-glycerides have a melting point range of 58-63° C.

In some embodiments, the lipid is fully hydrogenated cottonseed oil. In some embodiments, the fully hydrogenated cottonseed oil has a melting point range of 61-65° C.

In some embodiments, the lipid is fully hydrogenated soybean oil. In some embodiments, the fully hydrogenated soybean oil has a melting point range of 67-71° C.

In embodiments, the leavening agent comprises a mixture of sodium bicarbonate, and a dried buffered vinegar comprising an organic acid and a salt. In some embodiments, the weight of sodium bicarbonate ranges between 25 and 40%, between 28-36%, between 30-34%, between 31-33% of the total weight of the leavening agent. In certain embodiments, the weight of sodium bicarbonate per total weight of the leavening agent is 25%, 26%, 27%, 28%, 29%, 30%, 31%, 32%, 33%, 34%, 35%, 36%, 37%, 38%, 39%, or 40%. In specific embodiments, the sodium bicarbonate comprises 32% of the total weight of the agent.

In some embodiments, the weight of the encapsulated sodium bicarbonate ranges between 7 and 20% of the total weight of the leavening agent. In certain embodiments, the weight of sodium bicarbonate per total weight of the leavening agent is 7%, 8%, 9%, 10%, 11%, 12%, 13%, 14%, 15%, 16%, 17.0%, 17.1%, 17.2%, 17.3%, 17.4%, 17.5%, 17.6%, 17.7, 17.8, 17.9, 18%, 19% or 20%. In specific embodiments, the encapsulated sodium bicarbonate comprises 10% of the total weight of the agent. In specific embodiments, the encapsulated sodium bicarbonate comprises 16% of the total weight of the agent. In specific embodiments, the encapsulated sodium bicarbonate comprises 17.5% of the total weight of the agent. In some embodiments, the weight of the dried buffered vinegar may vary between 60 and 85% of the total weight of the agent. The remaining weight can be filled with corn starch or some other suitable filler as described further below.

### Dried Buffered Vinegar

Embodiments disclosed herein represent compositions for leavening baked goods during cooking and baking. In some embodiments, agents for leavening comprise a dried buffered vinegar.

The dried buffered vinegar may comprise an organic acid and its consumable salt, such as but not limited to, sodium acetate. The organic acid may include, but is not necessarily limited to, acetic acid, citric acid, malic acid, lactic acid, glycolic acid, tartaric acid, formic acid, proprionic acid, butyric acid, valeric acid, caproic acid, oxalic acid, benzoic acid, carbonic acid, or a combination thereof. In certain example embodiments, the organic acid is acetic acid and/or a consumable salt equivalent thereof. In certain example embodiments, the acetic acid is sourced from a vinegar. Source vinegar materials may include, for example, corn, sugar cane, glacial acetic, and apple cider. In certain example embodiments, the dried buffered vinegar comprises 1-12% acetic acid. In certain other example embodiments, the dried buffered vinegar comprises 4-8% acetic acid. The dried buffered vinegar may be prepared using standard buffering agents known in the art. An example buffered dried vinegar is WTI DV® available from WTI Inc. (Jefferson, GA).

In certain example embodiments, the dried buffered vinegar may include 5-9% organic acid, such as 5.0%, 5.1%, 5.2%, 5.3%, 5.4%, 5.5%, 5.6%, 5.7%, 5.8%, 5.9%, 6.0%, 6.1%, 6.2%, 6.3%, 6.4%, 6.5%, 6.6%, 6.7%, 6.8%, 6.9%, 7.0%, 7.1%, 7.2%, 7.3%, 7.4%, 7.5%, 7.6%, 7.7%, 7.8%, 7.9%, 8.0%, 8.1%, 8.2%, 8.3%, 8.4%, 8.5%, 8.6%, 8.7%, 8.8%, 8.9%, or 7.0%. In specific example embodiments, the dried buffered vinegar comprises citric acid at a 7% concentration. In specific example embodiments, the dried buffered vinegar comprises malic acid at a 6.9% concentration. In specific example embodiments, the dried buffered vinegar comprises lactic acid at a 7.6% concentration. In some embodiments, the dried buffered vinegar may comprise a combination of two or more organic acids. Such combinations may be made in ratios of 1:1, 1:2, 1:3, 1:4, 1:5, 1:6, 1:7, 1:8, 1:9, 1:10, 2:3, 2:5, 3:5, 4:5, or any other suitable ratio.

In certain example embodiments, the buffered dried vinegar composition may have a pH value of approximately 5.0 to approximately 6.5. In certain other example embodiments, the pH of the dried buffered vinegar is approximately 5.0 to approximately 6.4, approximately 5.0 to approximately 6.3, approximately 5.0 to approximately 6.2, approximately 5.0 to approximately 6.1, approximately 5.0 to approximately 6.0, approximately 5.0 to approximately 5.9, approximately 5.0 to approximately 5.8, approximately 5.0 to approximately 5.7, approximately 5.0 to approximately 5.6, approximately 5.0 to approximately 5.5, approximately 5.0 to approximately 5.4, approximately 5.0 to approximately 5.3, approximately 5.0 to approximately 5.2, or approximately 5.0 to approximately 5.1. In certain other example embodiments, the pH of the dried buffered vinegar is between approximately 5.4 to approximately 6.3, approximately 5.4 to approximately 6.2, approximately 5.4 to approximately 6.1, approximately 5.4 to approximately 6.0, approximately 5.4 to approximately 5.9, approximately 5.4 to approximately 5.8, approximately 5.0 to approximately 5.7, approximately 5.4 to approximately 5.6, or approximately 5.4 to approximately 5.5. In certain other example embodiments, the pH of the dried buffered vinegar is approximately 5.9 to approximately 6.1. As used in the context of describing pH value ranges above, “approximately” means a pH value within 0.05 of the stated pH values.

As described in the examples, the dried buffered vinegar has to have enough acid to fully neutralize the sodium bicarbonate. Each acid has its own neutralization value, which is the extent to which the acid will neutralize baking soda. For example, sodium aluminum phosphate (SALP) has a neutralization value of 100, meaning that a baking powder containing SALP would be 30% baking soda and 30% SALP, with the remaining 40% being a starch filler. Monocalcium phosphate (MCP) has a neutralization value of 80, and so a baking powder with 30% baking soda would need to contain 37.5% MCP to fully neutralize the baking soda, and 32.5% filler to bring the total to 100%.

In some embodiments, the dried buffered vinegar has a neutralization value of 35, 35.1, 35.2, 35.3, 35.4 35.5, 35.6, 35.7, 35.8, 35.9, 36, 36.1, 36.2, 36.3, 36.4, 36.5, 36.6, 36.7, 36.8, 36.9, 37, 37.1, 37.2, 37.3, 37.4, 37.5, 37.6, 37.7, 37.8, 37.9, 38, 38.1, 38.2, 38.3, 38.4, 38.5, 38.6, 38.7, 38.8, 38.9, 39, 39.1, 39.2, 39.3, 39.4, 39.5, 39.6, 39.7, 39.8, 39.9, or 40. In specific embodiments, the dried buffered vinegar has a neutralization value of 37.5. Neutralization value, in the context of leavening agents, is typically the parts by weight of baking soda from which all available carbon dioxide will be released by 100 parts by weight of a leavening acid.

In some embodiments, the agent may also comprise a filler, such as for example including, but not necessarily limited to, corn starch, calcium carbonate, calcium sulfate, calcium lactate, or calcium silicate.

In some embodiments, the dried buffered vinegar may be encapsulated in a lipid material, or combination of lipid materials, as described elsewhere herein. Selection of lipid material can be based on considerations such as fat profile, handling characteristics, consumer preferences, and melting temperature. A combination of lipids may provide a more desirable end-product and are within the scope of the methods and compositions described herein.

In some embodiments, the lipid material may be palm oil, as described. As such, the palm oil may be fractionated palm oil. In some embodiments, the fractionated palm oil has a melting range of 55-60° C.

In some embodiments, the palm oil may be fully hydrogenated palm oil. The fully hydrogenated palm oil may have a melting range of 58-63° C.

In some embodiments, the lipid material comprises mono- and di-glycerides. In some embodiments, the mono- and di-glycerides have a melting range of 58-63° C.

In some embodiments, the lipid is fully hydrogenated cottonseed oil. In some embodiments, the fully hydrogenated cottonseed oil has a melting range of 61-65° C.

In some embodiments, the lipid is fully hydrogenated soybean oil. In some embodiments, the fully hydrogenated soybean oil has a melting range of 67-71° C.

In some embodiments, the weight of the dried buffered vinegar ranges between 60% and 85%, between 61% and 84%, between 62% and 83%, between 63% and 82%, between 64% and 81%, between 65% and 80%, between 66% and 79%, between 67% and 78%, between 66% and 77%, between 65% and 76%, between 66% and 75%, between 67% and 74%, between 68% and 73%, between 69% and 72%, or between 70% and 71% of the total weight of the agent. In some embodiments, the weight of the dried buffered vinegar is 60%, 61%, 62%, 63%, 64%, 65%, 66, 67%, 68%, 69%, 70%, 71%, 72%, 73%, 74%, 75%, 75.1%, 75.2%, 75.3%, 75.4%, 75.5%, 75.6%, 75.7%, 75.8%, 75.9%, 76.0%, 76.1%, 76.2%, 76.3%, 76.4%, 76.5%, 76.6%, 76.7%, 76.8%, 76.9%, 77.0%, 77.1%, 77.2%, 77.3%, 77.4%, 77.5%, 77.6%, 77.7%, 77.8%, 77.9%, 78.0%, 79.0%, 80%, 81%, 82.0%, 82.1%, 82.2%, 82.3%, 82.4%, 82.5%, 82.6%, 82.7%, 82.8%, 82.9%, 83.0%, 84%, or 85% of the total weight of the agent. In specific embodiments, the dried buffered vinegar comprises 68% of the total weight of the agent. In specific embodiments, the dried buffered vinegar comprises 75.6% of the total weight of the agent and contains malic acid. In specific embodiments, the dried buffered vinegar comprises 77% of the total weight of the agent and contains citric acid. In specific embodiments, the dried buffered vinegar comprises 82.4% of the total weight of the agent and contains lactic acid.

In some embodiments, dried buffered vinegar is added in sufficient amounts for the sodium bicarbonate to be fully neutralized.

In some embodiments, ranges of percent ratios of encapsulated or unencapsulated sodium bicarbonate in the final composition described herein may vary based on the neutralization value of the dried buffered vinegar. In some embodiments, percent encapsulation of sodium bicarbonate can range between 10-40%. In specific embodiments, the composition may comprise 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40% encapsulated sodium bicarbonate. In some embodiments, ranges of percent ratios of encapsulated or unencapsulated sodium bicarbonate in the final composition described herein may vary based on the type of lipid coating material used or the melting temperature thereof. In some embodiments, the final composition may have ratios of encapsulated to unencapsulated sodium bicarbonate that are 1:9, 2:8, 3:7, or 4:6, or anywhere in between. In some embodiments, one may choose to use lipid-coated soda for slow-acting leavening agents that may not be clean label, such as for example, but not necessarily limited to, sodium aluminum phosphate or sodium aluminum sulfate. Such agents may have slower leavening function, which may find use in biscuits, muffins, refrigerated doughs, layer cakes, etc. Similarly, pH may be adjusted depending on application. In some embodiments, a lower pH may be needed for lighter crumb color, a higher pH for a darker crumb color, such as for example in chocolate products.

In some embodiments, dried buffered vinegar with reduced acidity may be used in the compositions described herein. This particular embodiment may require less sodium bicarbonate for neutralization, such as 22-28% encapsulated sodium bicarbonate. In specific embodiments, the composition may comprise 22%, 23%, 24%, 25%, 26%, 27%, or 28% encapsulated sodium bicarbonate. As described herein, the ranges of percent ratios of encapsulated or unencapsulated sodium bicarbonate in the final composition may vary based on the percent lipid content of the composition.

In some embodiments, ranges of percent ratios of encapsulated or unencapsulated dried buffered vinegar in the final composition described herein may vary based on the neutralization value of the dried buffered vinegar. In some embodiments, ranges of percent ratios of encapsulated or unencapsulated dried buffered vinegar in the final composition described herein may vary based on the type of lipid coating material used or the melting temperature thereof.

In some embodiments, the agents described herein may be used for making baked goods. In some embodiments, the agents described herein can be used for making refrigerated or frozen goods. In some embodiments, the agents described herein can be used for making dried mixes. Baked goods or refrigerated, frozen, or dried mixes, doughs, or batters that are within the scope of the invention may include, but are not necessarily limited to, bread, cake, cookies, scones, cupcakes, pancakes, donuts, bagels, biscuits, buns, muffins, crackers, pastries, pies, tarts, tortes, rolls, pretzels, or brownies.

### Methods for Making an Agent for Leavening Baked Goods

In some embodiments, the invention provides a method of making an agent for leavening baked goods. Such a method may comprise mixing together sodium bicarbonate, dried buffered vinegar, and a lipid material.

As described elsewhere herein, the dried buffered vinegar may have a neutralization value of 35, 35.1, 35.2, 35.3, 35.4 35.5, 35.6, 35.7, 35.8, 35.9, 36, 36.1, 36.2, 36.3, 36.4, 36.5, 36.6, 36.7, 36.8, 36.9, 37, 37.1, 37.2, 37.3, 37.4, 37.5, 37.6, 37.7, 37.8, 37.9, 38, 38.1, 38.2, 38.3, 38.4, 38.5, 38.6, 38.7, 38.8, 38.9, 39, 39.1, 39.2, 39.3, 39.4, 39.5, 39.6, 39.7, 39.8, 39.9, or 40. In specific embodiments, the dried buffered vinegar has a neutralization value of 37.5.

In some embodiments, the weight of the sodium bicarbonate may range between 25 and 40%, between 28 and 36%, between 30 and 34%, between 31-33% of the total weight of the agent. In certain embodiments, the weight of the sodium bicarbonate per total weight of the leavening agent is 25%, 26%, 27%, 28%, 29%, 30%, 31%, 32%, 33%, 34%, 35%, 36%, 37%, 38%, 39%, or 40%. In specific embodiments, the sodium bicarbonate comprises 32% of the total weight of the agent.

In some embodiments, the weight of the dried buffered vinegar ranges between 64-72% of the total weight of the agent. In some embodiments, the weight of the dried buffered vinegar is 64%, 65%, 66, 67%, 68%, 69%, 70%, 71%, or 72% of the total weight of the agent. In specific embodiments, the dried buffered vinegar comprises 68% of the total weight of the agent.

Fluid Bed Coating

In some embodiments, the sodium bicarbonate may be encapsulated in a lipid material, as described elsewhere herein. In some embodiments, encapsulation may be achieved by using a fluid bed coating process.

Fluid bed technology helps in achieving fast and uniform coating using air to mix, coat and dry the substrate at the same time. This technology originated from fluid bed dryers used for wet powder material drying operation. Fluid bed equipment was modified to coat tablets as an alternative innovation. However, this modification did not become popular for film coating tablets. The major concern during tablet coating using fluid bed equipment was high friability and compromise in core tablet appearance due to physical stress imparted during the fluidization process, compared to the much gentler pan coating process.

Fluid bed coating may be achieved using a bottom spray method which is widely used to film coat multi-particulate systems.

In the bottom spray method, the drying inlet air is passed upwards through a bottom perforated plate into the fluid bed chamber. This air passes inside and outside of the central cylinder (Würster column), which houses a spray gun perpendicular to a bottom plate, and parallel to the Würster column. The air is taken out of the equipment from the exhaust filters mounted on the top of the equipment. The material to be coated is loaded in the fluid bed chamber and fluidized. The inlet air is maintained at a certain velocity and temperature to help in both fluidization of the material as well as its drying during the coating operation. The height of the Würster column is adjusted such that pellets above the bottom plate (referred to as the Down-bed) are pulled in the Würster column due to the Venturi effect and pass through the liquid spray of coating solution from the spray gun positioned parallel to the column within. When the material being coated reaches the expansion chamber (referred to as the Up-bed), its velocity drops and it falls by gravity around the Würster column and is then recycled back to the coating zone by Venturi effect.

Examples of Fluid Bed Technology Processes Include:

Würster Process (Bottom Spray)

The Würster Process is the most commonly used type of fluid bed process for multiparticulate coating. In this process, there is a concurrent (same direction) movement of powder particles or pellets and liquid spray. The coating process occurs within the Würster column. Advantages of this method include the potential for moderate batch sizes and a uniformly coated product. Additionally, the solid-liquid contact area is well defined and the process has a wide range of applications. Limitations include the fact that nozzle access is tedious and there is a slow processing option. Typical applications include modified release coating, drug layering, and taste masking.

Granulator Process (Top Spray)

This is the most commonly used type of fluid bed process for granulation. In this process, there is a counter current (opposite direction) movement of powder particles or pellets and liquid spray. Advantages for this method include the ability to produce large batch sizes, there are options for fast processing, easy nozzle access, simple setup, and good mixing results. Limitations include highest potential for spray drying and agglomeration. Additionally, the solid-liquid contact area is not well defined. Typical applications include spray granulation, aesthetic film coating, taste masking, and hot melt coating.

Rotor Process (Tangential Spray)

This process was originally designed for the preparation of granulates (pellets), but has also become adapted for the film coating of multi-particulates. Powder particles or pellets move in a helical fashion due to spinning rotor disk on the bottom of the equipment. The liquid is sprayed within the moving powder or pellets. Advantages of this method include easy nozzle access, and the possibility of high spray rates. There is a fast option for powder drug layering. In addition, the solid-liquid contact area is well defined due to efficient mixing of powder bed. Disadvantages for this method include the fact that the product is subjected to high mechanical stress and there are also limitations in batch size flexibility. Typical applications include pelletization, dry powder drug layering, and modified release coating.

Spray-Chilling/Cooling Method

In other embodiments, encapsulation may be achieved by using a spray-chilling/cooling method. This technique is considered as the cheapest encapsulation method, and is commonly used to encase aromas and cause a sustained release in wet mediums. Moreover, it is used to modify liquid flavors into fine powders. The spray-chilling/cooling method is like spray drying, where flavor substances are emulsified into the fluid wall materials. Subsequently, the mixture is atomized from the feedstock. Finally, fine powders are generated as the droplets contact a cooling medium.

The spray chilling method involves the atomization of a molten wall material through a nozzle into a chamber with a carbon dioxide ice bath at the temperature of −50° C. Thus, the droplets are transformed into a coating film. This process can be applied to hydrophilic materials that may be degraded during heat treatment. Exemplary food products that can be prepared using this technique includes bakery products and dry soup, which are high in fat.

The spray cooling encapsulation method is akin to spray chilling, but the reactor temperature is different from the spray chilling method. A wall material entraps the core materials as they are spray cooled. Vegetable oils are suitable wall materials due to their melting point range (45-122° C.). Like other encapsulation techniques, these approaches have their own disadvantages, including particular handling plus storage circumstances.

The invention is further described in the following examples, which do not limit the scope of the invention described in the claims.

### EXAMPLES

### Example 1

### Designing a Baking Powder

Baking powders traditionally contain 30% baking soda by weight, with enough acid to fully neutralize the baking soda, with the remainder filled in with corn starch, or a similar filler. Each acid has its own “neutralization value” (NV) which is the extent to which the acid will neutralize baking soda. For example, sodium aluminum phosphate (SALP) has a NV of 100, meaning that a baking powder containing SALP would be 30% baking soda and 30% SALP, with the remaining 40% being a starch filler. Monocalcium Phosphate (MCP) has a neutralization value of 80, and so a baking powder with 30% baking soda would need to contain 37.5% MCP to fully neutralize the baking soda, and 32.5% filler to bring the total to 100%. With this in mind, Applicants set to find out the NV of dry vinegar powder. After a simple NV test using baking soda, dry vinegar powder and a pH meter in an aqueous solution, it was determined that dry vinegar powder has a NV of 37.5.

After the neutralization value (NV) for dry vinegar powder was determined, it was time to design a baking powder to test. Applicants started with two samples, product A and product B. Product A contained 85% baking soda and 15% coating. This is referred to as “85% activity” because the “active” component of the encapsulate, in this case the baking soda, is around 85% of the total weight of the product. Product B was a 70% active baking soda. To make a baking powder that contained the traditional 30% baking soda, it was necessary to start with 35.29% of product A. Using the NV of dried buffered vinegar would mean that Applicants would need 94.11% dry vinegar powder, which is impossible in a 100% formula. Applicants therefore weighed out the ingredients separately for the sake of simplicity in the cupcake formula that was tested, but for the sake of a baking powder itself, Applicants would be looking at 27.27% baking soda and 72.73% dry vinegar powder. This would mean that theoretically, the baking powder would contain 2.73% less baking soda than a traditional baking powder. In that case, it would be necessary to figure out if height, volume and crumb structure is similar to that of traditional baking powder, or if Applicants would need to recommend using slightly more of their baking powder compared to a control. The baking powder containing product B would need to be similarly calculated.

When the products were tested in the formulas below, it was shown that the cupcakes containing product A showed similar heights to the control. Cupcakes with product B appeared shorter visually as compared to both product A and the control. Some spotting was noticed within the liner of the cupcake. This is referred to as “bicarb spotting” and is a common side effect of using encapsulated ingredients in baking products. The mechanism of how or why this happens is not currently fully understood. However, the key finding of the test below is that the “clean label baking powder” is effective as a traditional chemical leavening reaction in a common baked good.

Test

TABLE 1

| | Control | A - BS 184 | B - BS 193 |
|---|---|---|---|
| Ingredient | g | | |
| Flour | 384 | 384 | 384 |
| Baking Powder | 12 | — | — |
| Salt | 3 | 3 | 3 |
| Eggs | 200 | 200 | 200 |
| Sugar | 270 | 270 | 270 |
| Butter | 340 | 340 | 340 |
| Vanilla Extract | 16 | 16 | 16 |
| Milk | 230 | 230 | 230 |
| BS 184 | — | 4.24 | — |
| BS 193 | — | — | 5.14 |
| Dry Vinegar | — | 9.62 | 9.62 |
| Powder | | | |
| Total | 1455 | 1456.86 | 1457.76 |

1. Line a muffin tin with cupcake liners. Preheat an oven to 350 degrees F.

2. In a large mixing bowl, use a hand mixer to cream the butter, and sugar together until light and fluffy. Add in milk, eggs, and vanilla extract and beat until combined.

3. Add in flour, baking powder, DV, and salt, and mix until just combined. Scrape the sides and bottom of the bowl to make sure everything gets mixed in.

4. Fill each cupcake liner with 60 g of batter. Bake at 350 for 20 minutes, or until a toothpick inserted into the center comes out clean.

5. Remove cupcakes from pan and transfer to a wire rack to cool completely.

TABLE 2
Average total aerobic bacteria and yeast and mold counts
in cupcakes prepared with the described agent.

| | | | | | | |
|---|---|---|---|---|---|---|
| Day 0 | Day 6 | Day 13 | Day 16 | Day 20 | Day 27 | Day 31 |

Aerobic Plate Count Log cfu/g

| Control: No treatment | 1.62 | 2.54 | 4.55 | Mold growth observed | | | |
|---|---|---|---|---|---|---|---|
| 111-T1: Agent 0.6% | 1.59 | 2.16 | 4.83 | 6.03 | 5.65 | 7.48 | Discontinued |
| 111-T2: Agent 1.00% | 1.76 | 1.84 | 2.24 | 2.19 | 2.04 | 4.59 | 3.89 |

Yeast and Mold Log cfu/g

| Control: No treatment | 0.60 | <0.60 | 1.30 | Mold growth observed | | | |
|---|---|---|---|---|---|---|---|
| 111-T1: Agent 0.6% | 0.90 | <0.60 | 1.45 | 3.10 | 2.40 | 2.18 | Discontinued |
| 111-T2: Agent 1.00% | 0.60 | <0.60 | <0.60 | <0.60 | 0.75 | 1.47 | <0.60 |

TABLE 3
Rise Measurements in cupcakes prepared using the agent.

| | Cupcake Rise (inches) | | | | | |
|---|---|---|---|---|---|---|
| | S1 | S2 | S3 | S4 | S5 | Average |
| Control | 2.00 | 2.00 | 2.00 | 1.94 | 2.00 | 1.99 |
| T1 Agent 0.6% | 1.81 | 1.75 | 1.81 | 1.81 | 1.81 | 1.80 |
| T2 Agent 1.00% | 1.94 | 1.88 | 1.88 | 1.94 | 1.94 | 1.92 |

Various modifications and variations of the described methods, pharmaceutical compositions, and kits of the invention will be apparent to those skilled in the art without departing from the scope and spirit of the invention. Although the invention has been described in connection with specific embodiments, it will be understood that it is capable of further modifications and that the invention as claimed should not be unduly limited to such specific embodiments. Indeed, various modifications of the described modes for carrying out the invention that are obvious to those skilled in the art are intended to be within the scope of the invention. This application is intended to cover any variations, uses, or adaptations of the invention following, in general, the principles of the invention and including such departures from the present disclosure come within known customary practice within the art to which the invention pertains and may be applied to the essential features herein before set forth.

1. An agent for leavening baked goods comprising sodium bicarbonate and dried buffered vinegar.

2. The agent of claim 1, wherein the dried buffered vinegar has a neutralization value of 35 to 40, optionally wherein the dried buffered vinegar has a neutralization value of 37.5.

3. (canceled)

4. The agent of claim 1, wherein the dried buffered vinegar comprises acetic acid, citric acid, malic acid, lactic acid, or a combination thereof; preferably wherein the dried buffered vinegar comprises acetic acid.

5. (canceled)

6. The agent of claim 1, wherein the sodium bicarbonate is encapsulated in a lipid material.

7. The agent of claim 6, wherein the lipid material is palm oil.

8. The agent of claim 7, wherein the palm oil is fractionated palm oil and preferably has a melting range of 55-60° C.

9. (canceled)

10. The agent of claim 7, wherein the palm oil is fully hydrogenated palm oil and preferably has a melting range of 58-63° C.

11. (canceled)

12. The agent of claim 6, wherein the lipid material comprises mono- and di-glycerides, and preferably wherein the mono- and di-glycerides have a melting range of 58-63° C.

13. (canceled)

14. The agent of claim 6, wherein the lipid material is fully hydrogenated cottonseed oil, and preferably wherein the fully hydrogenated cottonseed oil has a melting range of 61-65° C.

15. (canceled)

16. The agent of claim 6, wherein the lipid material is fully hydrogenated soybean oil, and wherein the fully hydrogenated soybean oil preferably has a melting range of 67-71° C.

17. (canceled)

18. The agent of claim 6, wherein the weight of sodium bicarbonate ranges between 28-36% of the total weight of the agent, preferably wherein the sodium bicarbonate comprises 32% of the total weight of the agent.

19. (canceled)

20. The agent of claim 6, wherein the weight of the dried buffered vinegar ranges between 64-72% of the total weight of the agent, preferably wherein the dried buffered vinegar comprises 68% of the total weight of the agent.

21. (canceled)

22. A method of making an agent for leavening baked goods comprising mixing together sodium bicarbonate, dried buffered vinegar, and a lipid material.

23. The method of claim 22, wherein the dried buffered vinegar has a neutralization value of 35 to 40, optionally wherein the dried buffered vinegar has a neutralization value of 37.5.

24. (canceled)

25. The method of claim 22, wherein the dried buffered vinegar comprises acetic acid, citric acid, malic acid, lactic acid, or a combination thereof, preferably wherein the dried buffered vinegar comprises acetic acid.

26. (canceled)

27. The method of claim 22, wherein the weight of the sodium bicarbonate ranges between 28-36% of the total weight of the agent, preferably wherein the sodium bicarbonate comprises 32% of the total weight of the agent.

28. (canceled)

29. The method of claim 22, wherein the weight of the dried buffered vinegar ranges between 64-72% of the total weight of the agent, preferably wherein the dried buffered vinegar comprises 68% of the total weight of the agent.

30. (canceled)

31. The method of claim 22, wherein the sodium bicarbonate is encapsulated in the lipid material using a fluid bed coating process or a spray-chilling/cooling method.

32. (canceled)

33. The method of claim 22, wherein the lipid material is palm oil fractionated palm oil, fully hydrogenated palm oil, fully hydrogenated cottonseed oil, or fully hydrogenated soybean oil.

34. (canceled)

35. (canceled)

36. The method of claim 22, wherein the lipid material comprises mono- and di-glycerides.

37. (canceled)

38. (canceled)
